(19) United States
(12) Patent Application Publication
(10) Pub. No.: US 2007/0064895 A1
(43) Pub. Date: Mar. 22, 2007

(54) System and method for telephone call information aliasing

(76) Inventors: Daniel H. Wong, San Jose, CA (US); Xuezhang Dong, Santa Clara, CA (US)

Correspondence Address: WILLIAM F. COLVELL, 1362 DARLING, OGDEN, UT, 84403, US

(21) Appl. No.: 11/223,649

(22) Filed: Sep. 9, 2005

(51) Int. Cl. H04M 1/56; H04M 15/06

(52) U.S. Cl. 379/142.09

(57) ABSTRACT

A method of providing an aliased telephone number provided. A user may request an alternate telephone number to protect his privacy when making calls. When the user transmits a call, a service provider detects that the call should be linked with an aliased telephone number. The provider may then substitute the aliased number for the originating number such that the recipient sees the aliased number on a caller identification module. Likewise, where someone sends a call to an aliased number, the service provider may cross reference the aliased number with an actual telephone number and either augment data information associated with the call with the actual number, or replace the aliased number with the actual number. The aliased number may be time sensitive and may have an expiration date. The system and method allow users to obtain telephone numbers for time-limited events.

### BACKGROUND

1. Technical Field

This invention relates generally to information transmitted and associated with a telephone call, including caller identification information, and more specifically to a system and method for substituting alternate information for that which is transmitted with an original call.

2. Background Art

Anonymity in making telephone calls is nearly a thing of the past. Not too long ago, a person could place and receive calls in complete privacy, giving out personal information only when they elected to do so. Today however, with the advent of caller identification systems and informational databases available on the Internet, a person must seriously consider who they are calling prior to making a telephone call. If the call is to a friend, presenting caller identification information such as “Incoming call: Mrs. Jones, 404-555-1212” may be very helpful, as the friend knows an acquaintance is calling. However, should Mrs. Jones call an unethical merchant, the merchant may record her telephone number, retrieve address and other information on-line, and then sell that information to other merchants. Soon, Mrs. Jones will be inundated with telephone calls offering to sell her everything from mildew remover to sun block. To further compound matters, should Mrs. Jones list her number on an Internet website, in an on-line chat room, or with an on-line retailer, those unwanted calls may continue for a very long time.

Telephone service providers have attempted to address this problem by allowing people to have their outgoing caller identification information blocked. For example, with some telephone services, a person may elect to have their number denoted “private” so that others to whom the person may place telephone calls will not be able to see from where the call has been made. In other systems, the user may be able to block the transmission of outgoing caller identification information by entering prefix keystrokes, *67 for example.

These prior art solutions present two problems, however. First, some people, wary of telemarketers, may configure their telephones to automatically block incoming calls that do not have associated caller identification information. Consequently, some calls may not be able to be completed.

Next, there are many instances where an outbound caller actually wants to have caller identification information displayed, just without a link to their home address or personal information. For example, if a person has a car for sale in a classified advertisement, they may desire to list a number in the ad from which they are able to place calls. In so doing, the recipient of a call would be able to recognize the incoming call's number as being that from the ad. This is suitable to the seller, so long as no other personal information may be gleaned from this advertised number.

There is thus a need for a system and method to facilitate outgoing caller identification information while protecting an outgoing caller's personal information.

### BRIEF DESCRIPTION OF THE DRAWINGS

The accompanying figures, where like reference numerals refer to identical or functionally similar elements throughout the separate views serve to further illustrate various embodiments and to explain various principles in accordance with the present invention.

FIG. 1 illustrates a telephone infrastructure system in accordance with the invention.

FIG. 2 illustrates one method in accordance with the invention.

FIG. 3 illustrates an alternate method in accordance with the invention.

FIG. 4 illustrates one example of a telephone display in accordance with the invention.

FIG. 5 illustrates an alternate example of a telephone display in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a method for providing alternate caller identification information with a telephone call. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of the method of providing alternate caller identification information associated with a telephone call. The non-processor circuits may include, but are not limited to, a radio receiver, a radio transmitter, signal drivers, clock circuits, power source circuits, and user input devices. As such, these functions may be interpreted as steps of a method to perform providing alternate caller identification information. Alternatively, some or all functions could be implemented by a state machine that has no stored program instructions, or in one or more application specific integrated circuits (ASICs), in which each function or some combinations of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

The present invention, which may be implemented as an advanced feature on a mobile, wireless or conventional telephone, allows a user to protect their privacy, yet still transmit caller identification information when making a call. The invention allows users to communicate with others without the need of blocking outgoing caller identification information, all the while protecting them from telephonic and short message service (SMS) spam and other uninvited communication.

The invention provides a system and method for allowing a user to obtain and transmit a second “aliased” phone number when making calls. In addition to being a number, the alias may include other information, like text indicating to what the alias refers. Continuing the automotive sale example from above, if the user receives a call directed to his aliased number, the display on the user's telephone may show from what number the call was placed, the aliased number to which the call was placed, and to what the alias refers. In this case, the alias may refer to information like “Vehicle Ad Currently Running in Paper.”

The aliased numbers in accordance with the invention may be 7, 10, or more numbers, as required, in accordance with standard telephone number formats in use with telephonic exchanges. The aliased numbers may be selected from unused telephone numbers, or may be selected from an unused area code.

In one embodiment, the telephone service provider, be it a mobile communications company, Internet-based Voice Over IP (VoIP) service provider, conventional telephone service provider, or other service provider, provides the user with a second, aliased telephone number. This aliased number is stored in a database maintained by the service provider. Once the provider detects a call being transmitted across the network, a Home Location Register (HLR) associates the user's original telephone number with the aliased telephone number. The provider may then substitute the aliased number for the original number and deliver the call to its original destination.

Likewise, in one embodiment incoming calls may be coupled with aliased information as well. When the service provider detects a call being directed at an aliased number, the HLR may associate the actual number with the aliased number. The provider may then either substitute or augment the aliased number with the actual number, and deliver the call to the actual number. Where the aliased number is augmented, the user may be able to see the aliased number on a display, alerting him to what the call is in reference.

In one embodiment, the aliased number may only be valid for a predetermined amount of time and may have an expiration date associated therewith. Where this is the case, and where the expiration date of the aliased number has expired, the provider may notify the user and provide him with the option of either extending the expiration date or obtaining an alternate aliased number. Additionally, any one user may obtain multiple aliased numbers, and may associate those aliased numbers with numbers stored in a local telephone contact list, so that when numbers from the contact list are dialed, that particular alias is displayed to the destination party.

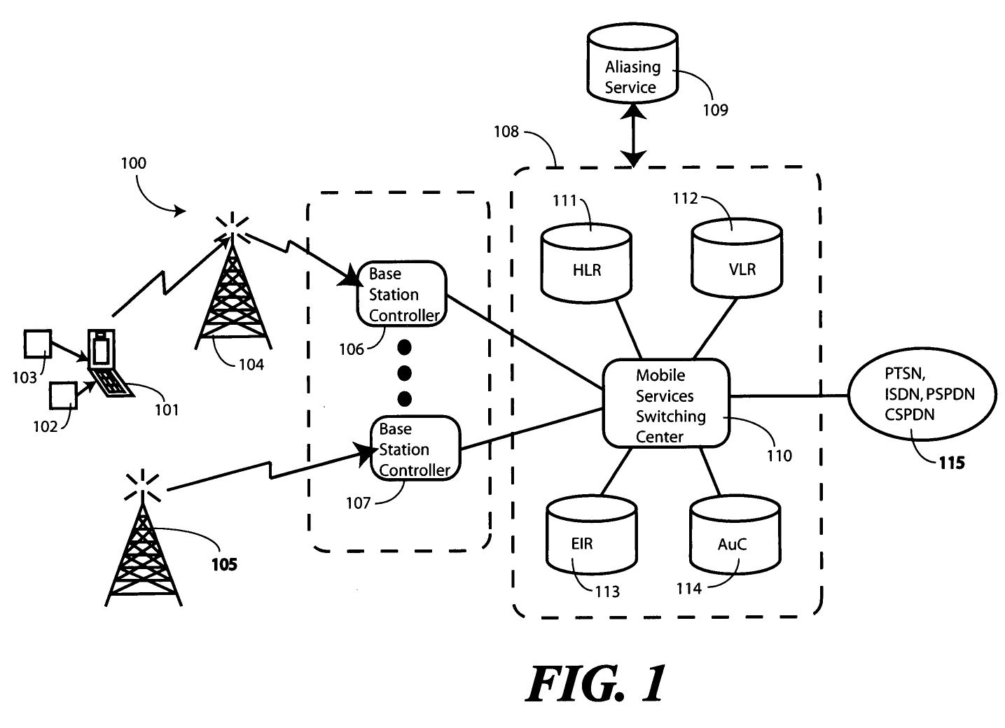

Turning now to FIG. 1, illustrated therein is one embodiment of a system 100 in accordance with the invention. A telephone 101 is used to transmit and receive telephone calls. While illustrated herein as a mobile telephone, it will be clear to those of ordinary skill in the art having the benefit of this disclosure that the invention is not so limited. It could be equally employed to conventional telephone systems and alternative telephone systems, like Internet-based VoIP systems.

Continuing with the illustrative mobile telephone 101, the mobile telephone 101 may include internal components for storing information, including an internal memory 103 and a Subscriber Identity Module (SIM) card 102 upon which non-volatile data may be written. The telephone 101 may store local directories and lists of telephone numbers in either the memory 103 or SIM card 102.

The telephone 101 makes calls by transmitting telephonic information to a tower 104 or base transceiver station. In addition to carrying voice data, the telephone call may also contain information data, including to whom the call is placed, from whom the call was placed, and other information. In mobile telephone communications this information is carried in a header. Such headers are well known in the art, and are taught by the various standards including the Global System for Mobile Communications (GSM) standards.

Upon receiving calls, the various towers 104,105 in the field transmit the calls to one of several base station controllers 106,107, which in turn route the calls through the service provider 108. The service provider 108 processes the calls through a mobile services switching center 110. In the mobile services switching center 110, the call may be interfaced with a variety of servers, each having unique information stored therein.

For example, the call may be referenced with an Equipment Identity Register (EIR) 113 that identifies the party from whom or to whom the call is directed. Additionally, the call may be referenced with an Authentication Center (AuC) 114 verifying the originating call came from the service provider's equipment, and was not a fraudulent, cloned call. Next, a Visitor Location Register (VLR) 112 may temporarily store data, such as SMS messages and pictures, which may be directed to a telephone number that is busy or unavailable. Finally, a Home Location Register (HLR) 111 stores both the telephone identification information and other information, including where the telephone 101 is located, what type of infrastructure, etc.

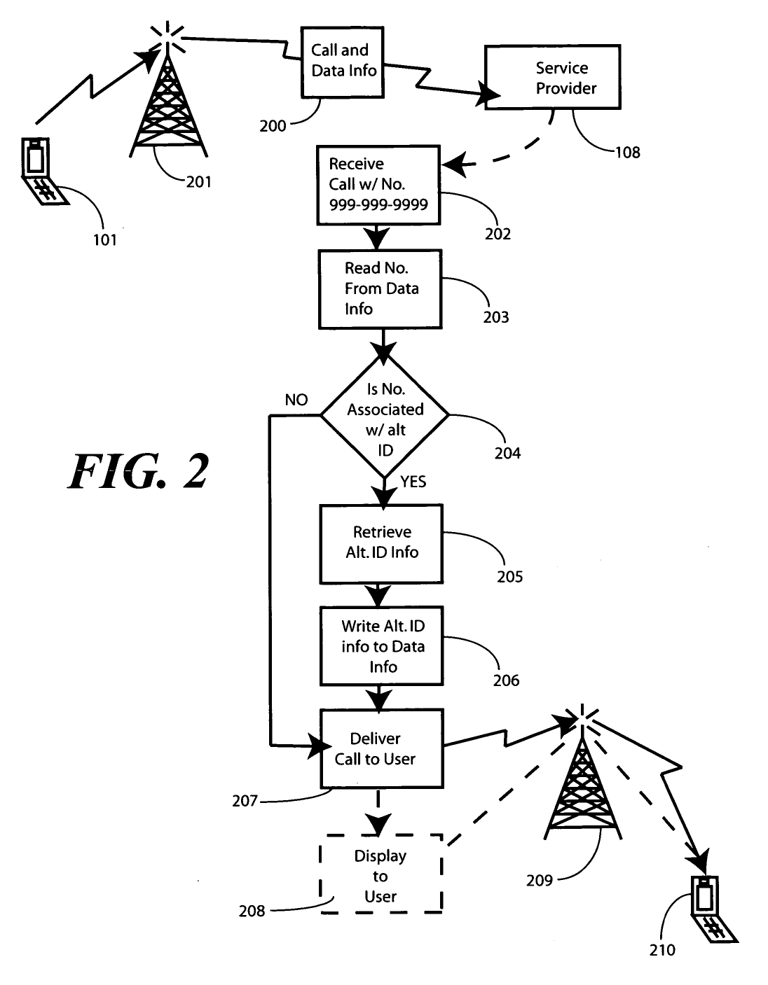

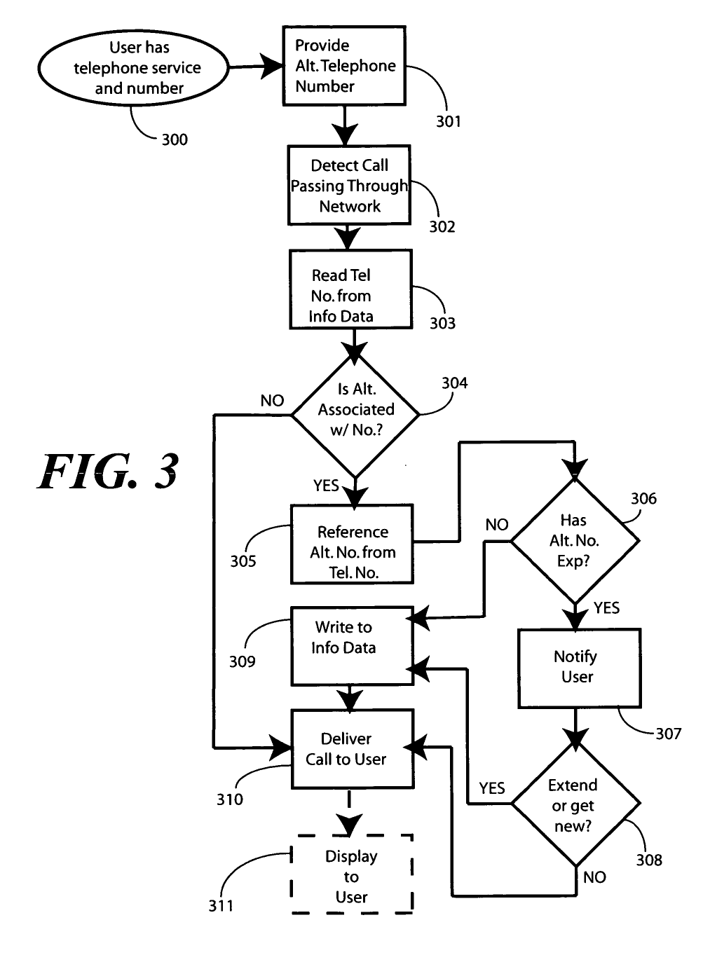

Since the HLR 111 maintains the telephone identification information, when a call is received that is directed to or from an aliased number, the HLR 111 references a database of aliased numbers 109. This database 109 and referencing service may be provided by a third party vendor, or may be provided by the service provider itself. In any event, the HLR 111 may reference the aliased number and augment or substitute the data information associated with the call with the aliased or actual number as will be described in the methods of FIGS. 2 and 3. Once this has been completed, the mobile services switching center 110 routes the call to a network 115, like a public switched network for delivery to the proper destination.

It will be clear to those of ordinary skill in the art having the benefit of this disclosure that other elements of the system 100 may perform the referencing described in the preceding paragraph. Since the HLR 111 maintains the telephone identification information, it is well suited to perform the function. However, other components, including the EIR 113, the VLR 112 or the AuC 114 could be programmed to perform this function, as these components operate in tandem with the HLR 111. Additionally, new components could be added to the system 100 to specifically perform this task.

Turning now to FIG. 2, illustrated therein is one embodiment of a method of presenting alternate caller identification information to a user. The method is triggered when a user places or receives a call from, or receives a call directed to, his telephone 101. His telephone 101 has an actual telephone number associated thereto. Since the method may be employed for both outgoing and incoming calls, the method will be first described as it applies to outgoing calls, and then as it applies to incoming calls.

For outgoing calls, the user places a call from the telephone 101 through a tower 201 or other infrastructure, and through the service provider 108 as was described in FIG. 1. The call 200, which may be a voice call, SMS message, multi-media message or other communication, includes data information. As noted above, the data information may be a header attached to the call with various informational components. In one embodiment, the telephone call includes at least one telephone number. For most all calls, the telephone call 200 includes a destination number and an originating number.

The system receives the telephone call 200 at step 202. As noted above, the telephone call 200 includes data information that contains at least one telephone number attached therewith. Where the telephone call 200 is an outgoing call, the information includes at least the originating telephone number associated with the telephone 101.

The telephone number is read at step 202. The system may reference data servers and databases to determine whether alternate caller identification information is associated with the telephone number at decision step 204. For example, the HLR may cross reference numbers as was described above. Where there is alternate caller identification information corresponding to the originating telephone number, for example an alternate telephone number from which the telephone call 200 should be referenced, the system retrieves this alternate caller identification number at step 205.

The system then writes the alternate caller identification information to the data information at step 206. For the automotive selling example recited above, the seller may desire to return a call to a potential buyer. When he does so, he may desire that the alternate caller identification information, e.g. the alternate telephone number, be displayed on the buyer's caller identification system. To accomplish this, the step of writing the alternate caller identification information to the data information 206 may include substituting the alternate telephone number for the originating telephone number. Once the writing is complete, the system delivers the telephone call 200 to a user by way of the particular infrastructure system being employed. For mobile phones, this may include a tower 209 to the recipient's telephone 210.

The system may configure both the telephone call 200 and the recipient's phone such that the telephone call 200, when received, displays the alternate caller identification to the user. Since this is done with call and hardware configurations, this step is shown in dashed lines at 208. The configuration may cause the alternate caller identification information to be presented to a user on a display.

It will be clear to those of ordinary skill in the art having the benefit of this disclosure that the alternate caller identification information need not be limited to an alternate telephone number. The alternate caller identification information may be any data that may be associated with a telephone call, including alternate telephone numbers, various text strings, various alphanumeric strings, pictures, electronic images, ring styles or ring tones. Any of these, or combinations of these, may be written to the data information associated with the call. Exactly what information is to be included will be determined by the user when he subscribes to the service.

Where the call is an incoming call, the system works in a similar, yet slightly different fashion. For the incoming call, presume for the moment that the caller has dialed an aliased number. This aliased number does not correspond with a user, location or particular hardware. It rather corresponds to an authentic telephone number. As such, it is handled slightly differently.

The caller dials the alternate number and transmits the telephone call 200 from a telephone to the alternate telephone number. The system receives the call, having data information including at least the destination telephone number, at step 202. The system reads the destination telephone number at step 203. At decision 204, the system determines that the alternate telephone number has been dialed. As such, the system retrieves the original telephone number corresponding to the alternate telephone number at step 205.

As this is an incoming call, the step of writing 205 may be employed in alternate ways. In one embodiment, where the caller has dialed an alternate telephone number, the step of writing the alternate caller identification information to the data information 205 includes substituting the alternate caller identification information, i.e. the actual destination number, for the alternate number. In such an embodiment, the recipient would see the origination number only on his telephone 210 when the call is delivered at step 207.

In a second embodiment, the step of writing the alternate caller identification information to the data information 205 includes augmenting the alternate telephone information with the alternate caller identification information. In other words, rather than replacing the alternate telephone number, the system may simply augment this number with the actual destination number. At step 207, the telephone call 200 will be delivered to the proper telephone 210 because the proper destination number was written at step 206. However, the recipient will be able not only to see the originating telephone number on the display, but the alternate telephone number as well. The alternate telephone number will alert the recipient to what the incoming call pertains.

Turning now to FIG. 3, illustrated therein is an alternate, time sensitive method of presenting alternate caller identification information to a user in accordance with the invention. The method presumes that a user has telephone service and a telephone number, as is indicated at 300. The service provider provides an alternate telephone number to the user at step 301. As noted above, the alternate telephone number may include other information, including text strings, alpha numeric strings, pictures, electronic images, ring styles, ring tones and combinations thereof.

The system detects and receives a telephone call at step 302. The telephone call, as above, includes data information identifying at least one telephone number, which may be a destination, alternate or origination telephone number. The system reads the telephone number at step 303.

At step 304, the system verifies that an alternate telephone number is associated with and corresponds to the telephone number included in the data information. The system then references the alternate telephone number from the telephone number included in the data information at step 305.

Since the alternate telephone number is time sensitive, it is available for use by the user only for a predetermined time. The alternate telephone number thus has an expiration date associated therewith. At decision 306, the system checks to see whether the expiration date has been reached. If it has not, then the system proceeds to step 309 where the alternate telephone number is written to the data information.

Where the expiration date has been reached or exceeded, the system first notifies the user of this fact at step 307. This notification may be accomplished by, for example, a SMS message. Since the expiration date has been reached, the system may offer the user an option of either extending the expiration date or obtaining another alternate telephone number, i.e. a third telephone number, at decision 308. If this offer is not accepted, the system simply delivers the call to the user at step 310. Where the offer is accepted, the system writes the applicable alternate information to the data information at step 309, and then delivers the call at step 310, optionally displaying the call at step 311 to a user on a display.

To recap, described herein is a method of presenting information associated with a telephone call to a user. In on embodiment, the method includes receiving a telephone call that includes data information identifying either a destination telephone number and/or an originating telephone number. A data string, which may be an alternate telephone number, a text string, an alpha numeric string, a picture, an electronic image, a ring style, a ring tone, or a combination thereof, is referenced from either the originating or destination telephone number. The data sting is then attached to the data information associated with the call, sometimes being substituted for originating or destination telephone numbers. The altered call is then delivered to the proper hardware, and may be presented to a user on a display.

In some embodiments, the data string may only be usable for a predetermined time and may have an expiration date associated therewith. Where this is the case, when the expiration date has not been reached, the data string will be attached to the data information associated with the call. Where the expiration date has been reached, the system may offer the user an option selected from extending the expiration date and obtaining an alternate data string.

Note that where multiple alternate numbers are in use by a user, the user may desire to associate a particular alternate number or data string with a particular entry in a telephone directory or other table of destination telephone numbers. Such a table may be stored either in a local memory in a local telephone (e.g. element 103 of FIG. 1) or in a local memory card (e.g. element 102 of FIG. 1).

Turning briefly to FIG. 5, illustrated therein is what such a table may look like when viewed upon a display. The telephone 500 includes a display 501 upon which visual information may be viewed. Once the user actuates the telephone directory, various entries 502,503 may be displayed on the display 501. Each entry may include a destination telephone number 504, and an alias number 505 that should be referenced when the destination telephone number 504 is dialed. Additionally, the entry 502 may include alias information 506. Returning to the car selling example above, the alias information 506 may read “number listed in car ad in paper” or a reasonable facsimile thereof.

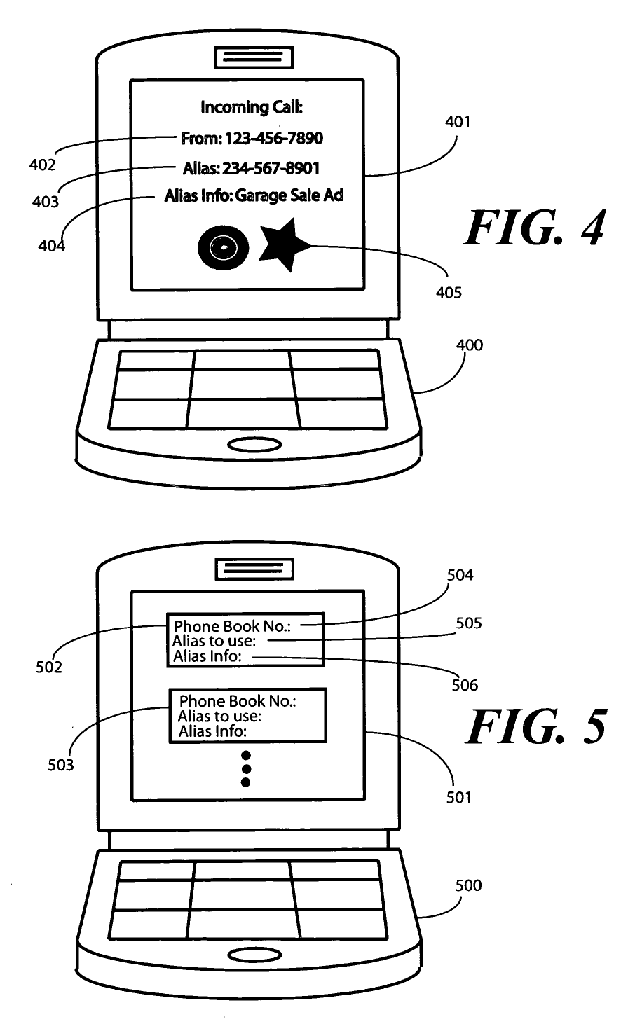

Note also that embodiments of the invention described above refer to presenting alternate caller identification information to a user on a display. Turning briefly to FIG. 4, illustrated therein is what such a display may look like. The phone 400 has a display 401 for viewing caller identification information. Where the call is an incoming call, and the data information was augmented with the destination number, the display 401 may present information indicating the originating telephone number 402. It may also present the alternate telephone number 403 and alternate information 403 to alert the recipient to what the call refers. Where the alternate caller identification information includes a particular picture 405, it may be displayed as well.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of presenting alternate caller identification information to a user, the method comprising the steps of:
a. receiving a telephone call comprising data information, wherein the data information includes at least one telephone number;
b. reading the at least one telephone number;
c. retrieving alternate caller identification information corresponding to the at least one telephone number;
d. writing the alternate caller identification information to the data information; and
e. delivering the call to the user.

2. The method of claim 1, wherein the alternate caller identification information is selected from the group consisting of alternate telephone numbers, text strings, alpha numeric strings, pictures, electronic images, ring styles and ring tones.

3. The method of claim 2, further comprising the step of presenting the alternate caller identification information to the user on a display.

4. The method of claim 2, wherein:
a. the telephone call comprises an outgoing call;
b. the at least one telephone number comprises an originating telephone number;
c. the alternate caller identification information comprises an alternate telephone number; and
d. the step of writing the alternate caller identification information to the data information comprises substituting the alternate telephone number for the originating telephone number.

5. The method of claim 2, wherein:
a. the telephone call comprises an incoming call;
b. the at least one telephone number comprises an alternate telephone number; and
c. the step of writing the alternate caller identification information to the data information comprises substituting the alternate caller identification information for the alternate telephone number.

6. The method of claim 2, wherein:
a. the telephone call comprises an incoming call;
b. the at least one telephone number comprises an alternate telephone number; and
c. the step of writing the alternate caller identification information to the data information comprises augmenting the alternate telephone number with the alternate caller identification information.

7. A method of presenting alternate caller identification information to a user, the method comprising the steps of:
a. providing an alternate telephone number;
b. detecting a telephone call comprising data information, wherein the data information includes at least one telephone number;
c. reading the at least one telephone number;
d. referencing the alternate telephone number from the at least one telephone number; and
e. writing the alternate telephone number to the data information.

8. The method of claim 7, wherein the step of providing an alternate telephone number occurs for a predetermined period of time and has an expiration date associated therewith.

9. The method of claim 8, wherein the step of writing the alternate telephone number to the data information occurs only where the expiration date has not been reached.

10. The method of claim 8, wherein when the expiration date has been reached, the method further comprises the step of offering to the user an option selected from the group consisting of extending the expiration date and obtaining a third telephone number.

11. The method of claim 7, wherein the alternate telephone number comprises additional data selected from the group consisting of text strings, alpha numeric strings, pictures, electronic images, ring styles and ring tones.

12. The method of claim 11, further comprising the step of presenting at least a subset of the data information to the user on a display.

13. A method of presenting information associated with a telephone call to a user, the method comprising the steps of:
a. receiving a telephone call comprising data information identifying at least a destination telephone number and an originating telephone number;
b. referencing at least a data string associated with a number selected from the group consisting of the destination telephone number and the originating telephone number;
c. attaching the at least a data string to the data information;
d. delivering the telephone call; and
e. presenting the at least a data string to a user.

14. The method of claim 13, wherein the data information further comprises data selected from the group consisting of alternate telephone numbers, text strings, alpha numeric strings, pictures, electronic images, ring styles and ring tones.

15. The method of claim 14, wherein the step of referencing the at least a data string occurs for a predetermined period of time and has an expiration date associated therewith.

16. The method of claim 15, wherein the step of attaching the at least a data string to the data information occurs only where the expiration date has not been reached.

17. The method of claim 16, wherein when the expiration date has been reached, the method further comprises the step of offering to the user an option selected from the group consisting of extending the expiration date and obtaining an alternate data string.

18. The method of claim 13, further comprising the step of associating the at least a data string with a particular entry in a table of destination telephone numbers.

19. The method of claim 18, wherein the table of destination telephone numbers comprises a telephone directory stored at a location selected from the group consisting of a local memory in a local radiotelephone, a local memory card disposed in a local radiotelephone and a computer server.

20. The method of claim 19, further comprising the step of organizing the table of destination telephone numbers by the at least a data string.
